(19) United States
(12) Patent Application Publication
(10) Pub. No.: US 2008/0266448 A1
(43) Pub. Date: Oct. 30, 2008

(54) Wearable personal video/audio device method and system

(76) Inventors: Gary Mark Reiner, Westport, CT (US); Patia Jean McGrath, Fairfield, CT (US); Ignatius B.D. Anandappa, Ridgefield, CT (US); Parag Goradia, Shelton, CT (US); Mark Lewis Grabb, Burnt Hills, NY (US); Mark Mastrianni, Westport, CT (US); John Erik Hershey, Ballston Lake, NY (US)

Correspondence Address: GENERAL ELECTRIC COMPANY (PCPI);C/O FLETCHER YODER, P. O. BOX 692289, HOUSTON, TX, 77269-2289, US

(21) Appl. No.: 11/796,907

(22) Filed: Apr. 30, 2007

(51) Int. Cl. H04N 5/225; H04B 1/38

(52) U.S. Cl. 348/376; 455/90.3; 348/E05.026

(57) ABSTRACT

A video and audio capture and transmission system is described in which a “see-what-I-see” or “CWIC” view is possible. A camera and audio sampling circuitry are provided in an earpiece designed to be comfortably worn by a user. The earpiece may be tethered to a power and control unit, or may be wireless. Video and audio signals are transmitted to a receiver wirelessly, permitting a hands-free capture of video and audio signals. The signals are then transmitted to viewers, such as via management or control devices. Access to the overall CWIC system may be controlled both for content providers and for viewers.

### BACKGROUND

The present invention relates generally to the field of video and audio communications devices, and more particularly to a device, method and system for capturing and transmitting unique personal user visual and audio inputs and sharing resulting visual and audio data with remote participants or devices.

Many systems have been developed and are currently in use for capturing video and audio inputs and storing or transmitting video and audio data. For example, conventional cameras, webcams, and so forth can be interfaced with computer systems to transmit video and audio files, either stored or in real time, over networks, including the Internet. Similarly, portable devices are well known for sending video and audio messages wirelessly, most prominently various cellular telephone technologies, Bluetooth protocols, and so forth. Moreover, telephone and video conferencing technologies are quite mature, and now commonly utilize high speed networks such as the Internet.

However, there is a growing and unsatisfied need for a business and personal-suitable hands-free technique for capturing, processing and disseminating video signals and ancillary information corresponding to the unique view of a user. That is, rather than a view made by a static camera or hand-held camera, there is a need for more personalized views to be transmitted by a user in a way that will more immediately and accurately depict what the user sees and hears. Existing camera technologies, for example, do not typically permit hands-free operation, and generally are inappropriate for conferencing and transmission of personal views, particularly using conventional video conferencing technologies. Experimental systems, such as helmets or the like equipped with cameras are more a curiosity than a practical solution for most applications, particularly in business.

The present need is motivated by a standing requirement for a person to be able to record, process, disseminate, and have understood, his or her personal viewpoint. There is a further need to enable the reception and viewing of unprocessed or processed views made previously or in real time by others.

While attempts have been made to create useful hands-free systems for video capture, none has yet successfully addressed the joint requirement of being both hands-free and allowing the user to go about his or her normal movement unencumbered by the video capture devices, while further incorporating and providing features vital to general business cases. The current need, as understood by the present invention, is for a system and components which can easily, unobtrusively, and comfortably integrate video and audio capture with the user, such as in a wearable device. In general, it is and will be necessarily that such devices provide suitably ergonomic means for accurately capturing high-quality video and audio signals, while providing the necessary electronics and sufficient electrical power for longer or medium-term operation.

### BRIEF DESCRIPTION

The invention provides a novel device, method and system designed to respond to such needs. The invention may be based upon a camera which is designed to be worn on the head of a user, particularly in an ergonomic earpiece. The camera may be powered by a power unit coupled to the earpiece by a light-weight tether cable or wire. In certain embodiments, the earpiece may be completely wireless, having its own power supply. The camera captures video scenes similar or identical to those that would be seen by the wearer. The earpiece may also capture audio input, both from the environment of the particular scene as well as voice input by the wearer. The earpiece may further provide audio output for the wearer or, more generally, that may be heard by others in the presence of the wearer.

The earpiece may transmit video and audio data, encoded or un-encoded, via the same cabling or wirelessly. In certain embodiments, the earpiece or a separate worn device then transmits the video and audio signals to a receiver which can store, process or further transmit the video and audio inputs to other locations. For example, the receiver may be incorporated into an application-specific or general purpose computer that receives the video and audio input and transmits it to others via a network, including the Internet. The overall structure of the system might include a central manager or cell controller that serves as a hub for one or more such transmissions. The cell controller may regulate access to the video and audio input by both the signal provider and to other viewers and auditors, such as through conferencing procedures, subscriptions, and so forth.

In certain presently contemplated embodiments, the overall system, with the worn device and cooperating components forms what may be termed a “see what I see” (“CWIC”) system. That is, the overall system permits others to experience much the same video and, where provided, audio input as the wearer of the device experiences.

### DRAWINGS

These and other features, aspects, and advantages of the present invention will become better understood when the following detailed description is read with reference to the accompanying drawings in which like characters represent like parts throughout the drawings, wherein:

FIG. 1 is an elevational view of an earpiece and transceiver designed to be worn by a user for capture and transmission of video and audio signals in a CWIC system;

FIG. 2 is a diagrammatical overview of certain of the functional components which may be included in the elements shown in FIG. 1, along with components that cooperate to receive video and audio data and to transmit commands to the device, where appropriate;

FIG. 3 is a diagrammatical view of an exemplary earpiece designed for wireless operation;

FIG. 4 is a diagrammatical view of an exemplary earpiece permitting adjustment of the view captured during operation;

FIG. 5 is a diagrammatical view of another exemplary earpiece having a built-in interface for configuring the device, powering the device, charging the device, and so forth;

FIG. 6 is a diagrammatical representation of additional functional components which may be included in the wearable device of a CWIC system for providing additional information regarding location and orientation of the device, and for triggering certain operations; and

FIG. 7 is a diagrammatical overview of a CWIC system utilizing wearable devices in accordance with aspects of the invention.

### DETAILED DESCRIPTION

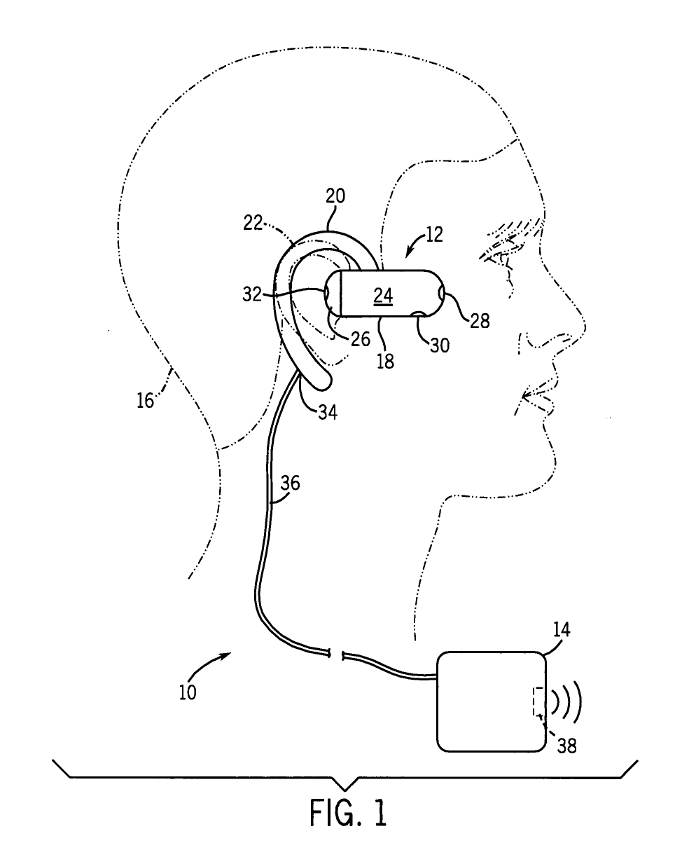

Turning now to the drawings, and referring first to FIG. 1, a “see-what-I-see” or “CWIC” video and audio capture system is illustrated generally and designated by the reference numeral 10. The capture system is designed to be worn by a user and to capture visible scenes and, where provided, audible sounds essentially similar to those experienced by the wearer. In the illustrated embodiment, the CWIC capture system includes an earpiece 12 that works in cooperation with a power/transceiver unit 14. The earpiece is designed to be worn by the wearer 16, and itself includes a video/audio capture device 18 mounted on a support 20. The support 20 may be configured in various manners, and is preferably ergonomically formed to fit comfortably on the ear 22 of the wearer. The capture device 18, in the illustrated embodiment, includes a housing 24 in which sensors and associated circuitry are packaged, as described in greater detail below. The housing may have a rear cover 26 for accessing components within the housing and for packaging the components during manufacture. Although not illustrated, other support structures may also be envisaged, including light-weight bands that extend at least partially around the wearer's head to help hold the earpiece in place when in use.

Various sensors and subsystems may be included in the video/audio capture device 18. In a presently contemplated embodiment, the device will include one or more cameras for capturing video scenes, as well as one or more microphones for capturing sound. In the illustrated embodiment of FIG. 1, for example, a lens 28 is provided in a front position on the device to capture views seen by the wearer, typically in the visible spectrum. However, as will be appreciated by those skilled in the art, the optics and sensitivity of the device may permit the capture of scenes in near visible wavelengths, such as in the infrared spectrum. The microphone aperture 30 allows for audio data to be picked up by the device. A speaker 32 may also be provided in the housing or may extend from the housing, to allow the wearer to interface interactively with remote parties in real-time exchanges.

In the embodiment illustrated in FIG. 1, the capture device 18 is coupled to the power/transceiver unit 14 by means of a tether connection 34 to which a light-weight cable 36 is connected. The cable may be permanently secured to the tether connection, or may be separable from the connection, such as by means of a suitable connector (not shown). As described in greater detail below, the cable 36 allows for power to be transmitted from the power/transceiver unit 14 to the earpiece 12, and for the transmission of audio and video signals from the earpiece, and audio signals to the earpiece, particularly where a speaker is provided for the wearer. Moreover, in the view shown in FIG. 1, a transceiver 38 is provided in the power/transceiver unit 14 that permits wireless transmission of video and audio signals from the capture system, and for receiving audio signals for the wearer, where a speaker is provided. In one presently contemplated alternative arrangement, the earpiece may be retractably connected to, or pluggable into the unit 14. This arrangement offers the potential for recharging the earpiece by virtue of a connection to the unit 14.

The embodiment illustrated in FIG. 1 is presently contemplated to permit significant reduction in size and weight of the earpiece 12. As described in greater detail below, while current technologies motivate separation of power supplies, and certain processing functions to the power/transceiver unit 14, developing technologies may permit some or all of the circuits to be included in the earpiece, while still providing an ergonomic and comfortable device to wear. Such alternatives are described in greater detail below.

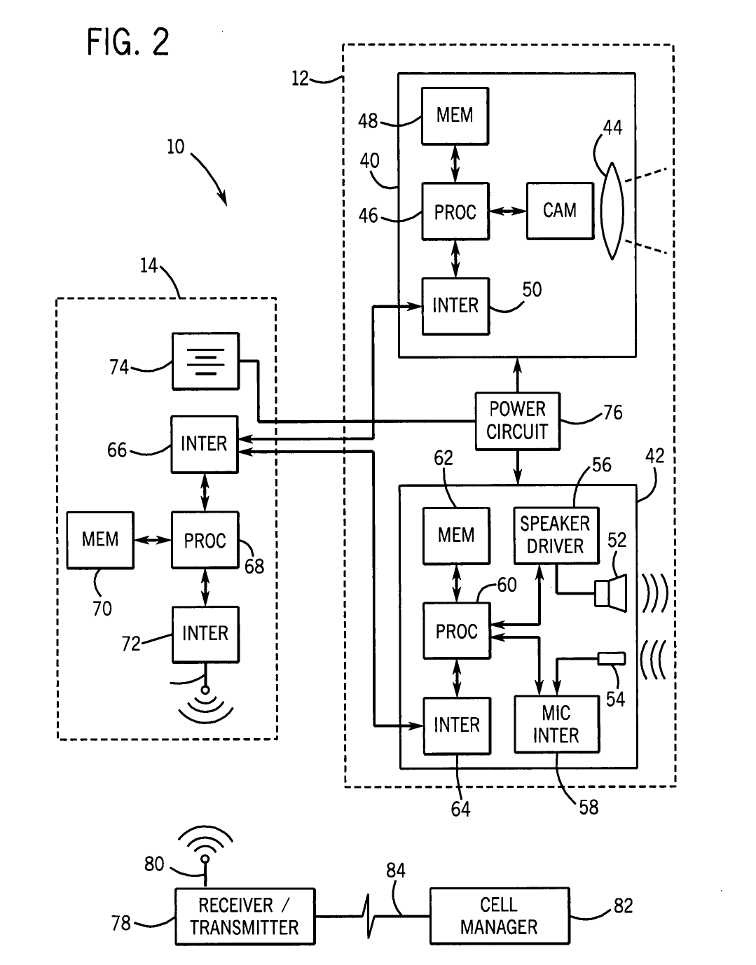

FIG. 2 is a diagrammatical overview of certain of the functional circuitry and subsystems that may be included in the CWIC capture system 10. As noted above with reference to FIG. 1, the system will, in a presently contemplated embodiment, include an earpiece 12 and a power/transceiver unit 14. The earpiece itself will typically include video circuitry, designated generally by reference numeral 40, and where audio signals are captured and provided, audio circuitry 42. The video circuitry itself will further include one or more cameras and associated optics, as designated generally by reference numeral 44. Any suitable video or camera device may be employed, such as CCD cameras, CMOS cameras, or similarly functioning technologies capable of forming video signals based upon received light. Signals from the camera are provided to a processor 46 which may include a filtering circuitry, sampling circuitry, analog-to-digital conversion circuitry, and so forth. In certain embodiments, it may be advantageous to reduce the functionality of the processing circuitry 46, so as to reduce power consumption in the earpiece. However, in general, some type of processing of the video signals will be performed in the earpiece for transmission to remote locations, including to unit 14. The processor 46 is generally served by support circuitry, particularly by memory 48 which stores programs or protocols implemented by the processing circuitry, as well as video data, where appropriate. The memory may also serve to store configuration settings for the processor, the camera, and other functional components. The video circuitry 40 will also typically include interface circuitry 50, such as communications circuitry for transmitting video signals from the video circuitry 40 to the power/transceiver unit 14.

The audio circuitry 42 similarly includes a number of functional components. In the illustrated embodiment, for example, a speaker 52 is provided as well as a microphone 54. The speaker is associated with a speaker driver circuitry 56 for powering the speaker and transforming received audio signals into appropriate signals to produce the audio output. Microphone interface circuitry 58 similarly receives signals from microphone 54, and may perform such functions as filtering, analog-to-digital conversion, encoding, decoding, encryption, compression and so forth. The speaker driver 56 and microphone interface 58 are coupled to a processor 60 which is programmed to carry out audio signal processing. Support circuitry may include memory circuitry 62 which serves to store routines executed by processor 60, and may store, at least temporarily, audio signals for transmission to the power/transceiver unit 14 through the intermediary of an interface 64.

The power/transceiver unit 14 similarly includes one or more interfaces 66 which communicate with interfaces 50 and 64 of the earpiece to receive video signals, and to send and receive audio signals. The interface circuitry 66 is coupled to processing circuitry 68 which coordinates the receipt and transmission of the video and audio signals, as well as their transmission to remote devices. The processing circuitry 68 may be served by a number of support circuits, such as memory circuitry 70 for storing the routines executed by the processing circuitry 68. Memory circuitry 70 may also store configuration parameters, data exchange protocols, and so forth needed for receipt and transmission of the video and audio signals, particularly their transmission to remote devices as described below. An interface circuit 72 is thus provided to permit wireless exchange of data between the power/transceiver unit 14 and remote devices.

It should be noted that other circuitry that may be included in the earpiece, the power/transceiver unit 14, or both may include circuitry for buffering, storing and forwarding audio and video signals based on the availability of the underlying network or connection. Similar circuitry may be included in the circuitry to which the signals are sent, as discussed in greater detail below. Similarly, the earpiece or the power/transceiver unit, or both, may include indicia to notify users and persons whose images or voices may be captured by the system that the system is currently recording. Such indicia may include, for example, light emitting diodes, blinking lights, and so forth. Still further, the earpiece or the power/transceiver unit, or both may include an indicator, and where desired, a selector, for indicating and selecting among a plurality of signal transport technologies (e.g., 2G, 3G, Wifi, WiMax, and so forth). For example, the system may automatically select a “best” transport mechanism or protocol, such as based upon a signal or connection strength, or may enable a user to select such technologies.

Still further, the circuitry of the earpiece and/or the power/transceiver unit may include one or more sensors for detecting environmental conditions or conditions of the wearer or even of persons or equipment in the environs of the user. By way of example, such sensors may include temperature sensors, chemical sensors, sensors for detecting vital signs, and so forth. In exemplary implementations, for example, a fire fighter or service technician may need to detect temperatures or air qualities. A physician may need to detect vital signs of a patient. The circuitry of the system, then, may collect sensed signals from such sensors, encode the information in an appropriate protocol and transmit the encoded information along with audio and/or video signals collected via the system.

In the presently contemplated embodiment illustrated in FIG. 2, a power source 74, such as one or more batteries, is included in the power/transceiver unit 14, and is coupled to power circuitry 76 in the earpiece. Relatively low levels of power will be typically demanded by the circuitry of the earpiece, and these may be distributed by the power circuitry 76, which may also perform voltage regulation functions, and so forth.

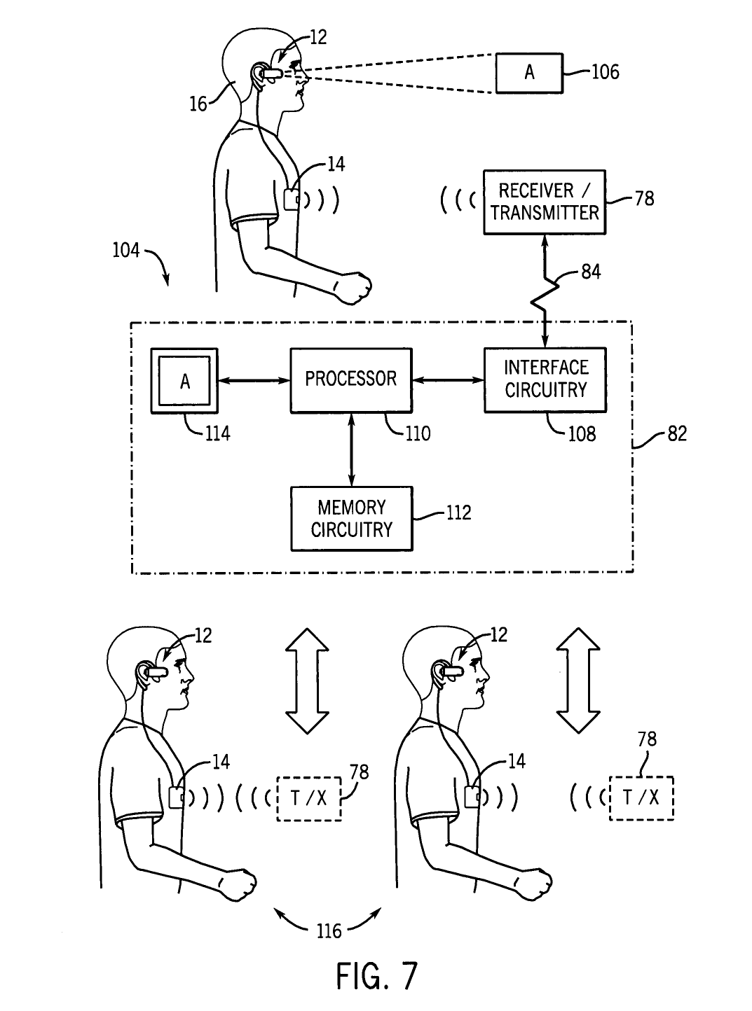

The interface circuitry 72 of the power/transceiver unit 14 is equipped to communicate wirelessly with one or more receiver/transmitter units 78. Unit 78 may, in some embodiments, include a general purpose or application-specific computer coupled to a wireless interface, as designated generally by reference numeral 80 for exchanging data in accordance with any one or many known wireless protocols. Wireless protocols may include, for example, protocols known by the designations Bluetooth, ZIGBE, IEEE 802.11. Other presently contemplated wireless transmission technologies may include infrared connections, radio frequency connections, cellular telephony protocols, and so forth. In presently contemplated embodiments, the receiver/transmitter unit 78 will be local to the user. However, in future embodiments, particularly where longer range wireless communication is possible directly from the CWIC capture system 10, significant distances may exist between the capture system and the receiver/transmitter unit. Indeed, cellular protocols may be implemented directly in the CWIC capture system 10, with video and audio signals being transmitted directly via a cellular or similar network. In the illustrated embodiment, the receiver/transmitter unit 78 is coupled to a cell manager or similar controller, designated by reference numeral 82, via a network connection 84. The cell manager may carry out such functions as identifying permitted users or controlling access to the video and audio input from the capture system, controlling access by the capture system to a data transmission network, and so forth, as described in greater detail below with reference to FIG. 7.

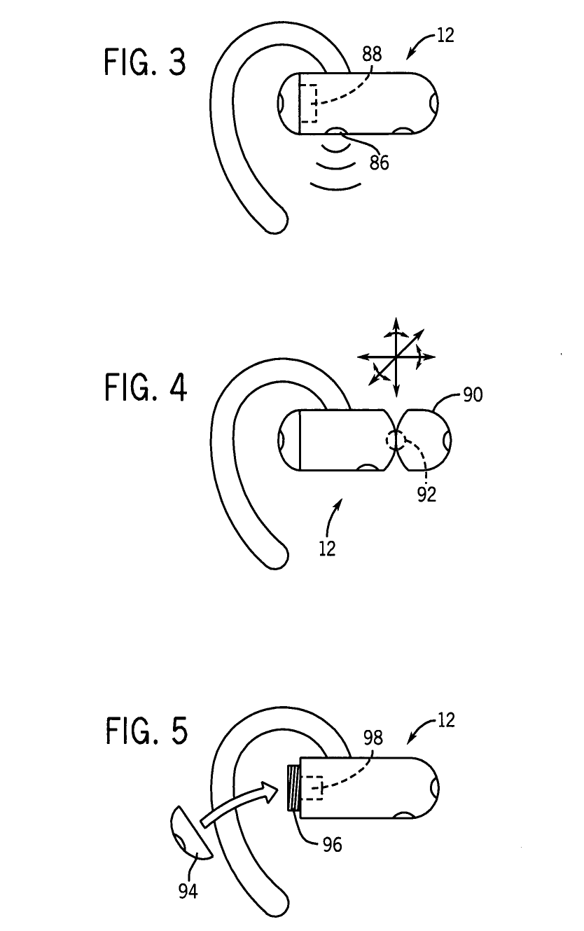

A number of variations may be envisaged for the capture system, and particularly for the earpiece 12. Certain of these are illustrated in FIGS. 3, 4, and 5. In the alternative implementation of FIG. 3, a completely wireless earpiece 12 is provided. Functional components of the wireless earpiece may be essentially similar to those described above. However, the wireless earpiece is provided with a wireless transceiver 86 that allows it to communicate data in accordance with a wireless protocol such as one of the protocols or techniques mentioned above. To permit the earpiece to function wirelessly, that is, free from wire connections to a power/transceiver unit or any similar device, an on-board battery 88 may be provided. In the alternative configuration of FIG. 4, an orientable camera 90 positioned on a front end of the earpiece and coupled to the earpiece via a multi-axis joint 92. In the simplest implementation, the joint 92 may permit one degree of freedom in the movement of the camera 90, although other degrees of freedom of movement may be provided. The implementation of FIG. 4 allows for the camera 90 to be oriented in a direction that most closely matches the view of the wearer. The alternative configuration of FIG. 5 includes a removable rear cap 94 which may be selectively removed from the housing of the earpiece, such as via snap engagement, threads 96, or otherwise to expose a plug-in interface, receptacle or jack 98. The jack may allow for interfacing with a conventional cable, such as a USB, mini-USB, compact flash, SD, mini-SD, or other communications cable. Such cables may be used to access programming within the device, reprogram the device, set parameters, such as for video and audio sampling, spatial resolution, and so forth. Of course, these and other innovations may all be incorporated into the earpiece, where desired.

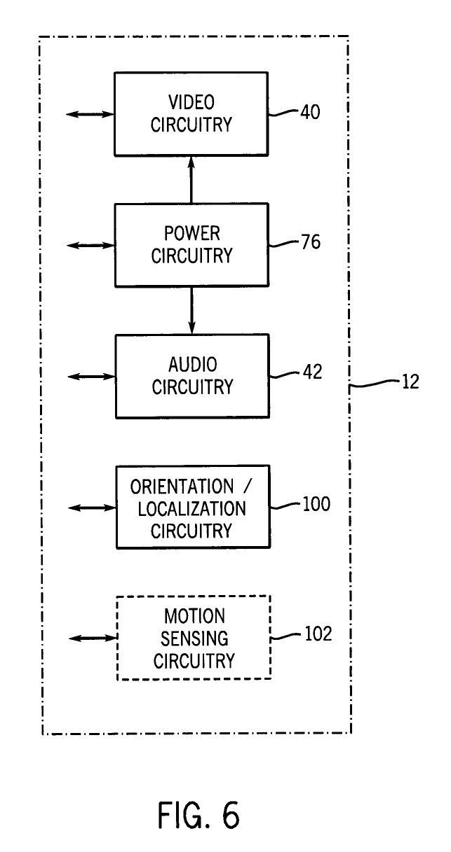

FIG. 6 illustrates additional functional circuitry that may be included in the earpiece to provide enhanced functionality as described below. The earpiece, in this implementation, may include video circuitry 40 and audio circuitry 42, as described above, along with power circuitry 76. Moreover, in the implementation of FIG. 6, orientation/localization circuitry 100 may be provided. Such circuitry may include, for example, electronic compass inputs, global positioning system circuitry, RF sensors, and so forth capable of determining the location or relative location of the earpiece or of the wearer, and in certain implementations, the orientation of the wearer. This information may be used, for example, to adjust views displayed by a remote viewer as described below. Moreover, the earpiece may include motion sensing circuitry, designated generally by reference numeral 102. Such circuitry may include, for example, one or more accelerometers capable of determining when the earpiece is being moved, or worn, or when the wearer has changed positions such that a new view is available. As described below, for example, video and audio capture may be initiated or suspended based upon detected movement of the earpiece, so as to reduce power consumption and improve efficiency of bandwidth and memory utilization.

The foregoing arrangements are designed to function in a system which, in the present context, is termed the CWIC system. The CWIC system may be designed to provide for controlled access to networked or conference components in much the same way that conferencing models are presently used. That is, the wearer or user of the CWIC capture system may be required to maintain an up-to-date subscription for transmission of video and audio signals via the CWIC system. Other models may be based upon a pay-per-use arrangement with the user. In certain implementations, therefore, the user may be required to access the CWIC system by appropriate input of access code, such as via the receiver/transmitter unit 78 described above. This information may include, for example, user identification and password authentication, encryption protocols, session identifications, and so forth. The CWIC system itself may include a number of interface components as generally represented in FIG. 7. Where desired, encryption and transition between encrypted and non-encrypted audio and video content over wired or wireless connections to the remote systems may be provided where data may be decrypted and displayed or played based upon individual user characteristics (such as subscriptions, security levels, permissions, and so forth).

In the embodiment illustrated in FIG. 7, the CWIC system 104 makes use of one or more CWIC capture systems 10 worn by one or more users 16. The capture system, then, generates video and audio signals which may be considered to represent a scene 106, designated by the letter “A” in FIG. 7. Any suitable update or sampling rate may be used to provide the desired level of video or audio quality. Presently contemplated embodiments, for example, may employ a video sampling rate of 30 frames/second, although lower rates may be used. Various spatial resolutions may be employed for the video as well, such as 320×320 lines, employing cameras of from 500 kpixel to 2 Mpixel cameras, although other spatial resolutions may be afforded. Moreover, various wireless bandwidths may be used, with presently contemplated bandwidths being 200 kbit/second. Bluetooth wireless communications, for example, may provide at present up to 1 Mbit/second transmission.

In the embodiment illustrated in FIG. 7, the video and audio signals are received by the receiver/transmitter 78 and are then transmitted to the cell manager 82 via the network connection 84. The cell manager itself may include interface circuitry 108 configured to receive and decode the video and audio transmissions. Processing circuitry 110 allows for processing of the signals, and, where desired, reformatting the signals for display or retransmission. The processing circuitry 110 will be served by support circuitry, such as memory circuitry 112 which stores routines executed by the processor, and which may also store, temporarily or on longer term bases, audio and video signals, such as in a form of transmission files for specific sessions. Other memory circuitry may be provided beyond the cell manager 82 itself for this purpose. Indeed, entire libraries or repositories of video and audio files may be provided in the system. In general, the cell manager may also include one or more display or interface devices 114 which reproduce the scenes and audio received from the wearer 16.

The CWIC system 104 may provide for individual receipt, storing, or communication of video and audio signals from single users or wearers. However, it should be noted that the system may interface with any number of wearers or users of capture systems 10, as indicated by reference numeral 116 in FIG. 7. More generally, the model for the overall system may allow for conferencing services to be provided, such as on a subscription or pay-per-use basis, with multiple video providers providing video and/or audio to the system, and multiple viewers logging into the system and accessing specific video and/or audio on appropriate paid license or free bases. The processing circuitry 110, in such instances, may include more elaborate back office functionality to prompt payment or verification of access rights, verification of passwords, and so forth before video providers can post content, or before viewers can view content.

In presently contemplated embodiments, to provide greater facility to the user in interfacing with the CWIC system, visible and/or audible indicators may be provided to inform the user that video and/or audio data is being acquired or is streaming through the system. Such indicators may include, for example, non-intrusive beeps, periodic beeps, or other audio clues. Similarly, visual indicators, such as colored LEDs, blinking LEDs and so forth may be provided for the same purpose. The system may also respond to audio commands, where desired, allowing the user complete hands-free control. For example, the user may speak commands such as “start streaming video” to control operation of the capture system. Similarly, particular audio or visual feedback may be provided to inform the user of the quality or bandwidth or resolution of the video and/or audio signals, the cost associated with transmission, and so forth.

Where desired, the earpiece, the power/transceiver unit, or the remote components with which these cooperate may include delay circuitry that adds a desired delay before transmission of the audio and video signals to a connected user or receiver of the content. Such delays may allow for the user of the system or for controllers at the CWIC system level to prevent transmission of audio signals, video signals, or both, should the system inadvertently capture inappropriate content.

Exemplary uses of the system described above may be many. As noted above, the system may be used, for example, for replacement of conventional video conferencing. Moreover, the system may be used to allow for expert direction of less trained personnel, such as for servicing, part replacement, troubleshooting of complex systems and equipment, and so forth. More generally, the system may be used for any application where video and audio input is desired, and where a view conforming much more closely to that experienced by the user is desired, as compared to existing video capture and transmission systems. Thus, the system may also provide collaboration and sharing of public and/or private (secure) content along with a medium that will enable users of the system to interact with the producers of the content along with the content itself.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for the capture and transmission of video and audio data comprising:
an earpiece configured to be worn by a user, the earpiece including video and audio circuitry for capturing video and audio signals corresponding to views seen by the user; and
power and control circuitry for powering the video and audio circuitry and for controlling transmission of the video and audio signals from the earpiece to a separate receiving device.

2. The system of claim 1, wherein the power and control circuitry is coupled to the earpiece via a tethered cable.

3. The system of claim 2, wherein the power and control circuitry is configured for wireless communication to at least one remote device.

4. The system of claim 1, wherein the power and control circuitry is integrated into the earpiece.

5. The system of claim 4, wherein the earpiece is configured for wireless communication to at least one remote device.

6. The system of claim 1, wherein the earpiece includes an orientable camera capable of being positioned to capture scenes substantially identical to those viewed by the user.

7. The system of claim 1, wherein the earpiece includes at least one processing circuit for processing received video and/or audio signals prior to transmission to a remote device.

8. The system of claim 7, wherein the earpiece includes an interface for coupling the earpiece to a programming device for accessing or altering programming of the at least one processing circuit or for setting parameters of the video and audio circuitry.

9. The system of claim 1, wherein the earpiece or the power and control circuitry is configured to generate an audible or visual feedback for the user to indicate when video and/or audio signals are being captured or transmitted to a remote device.

10. A system for the capture and transmission of video and audio data comprising:
an earpiece configured to be worn by a user, the earpiece including video and audio circuitry for capturing video and audio signals corresponding to views seen by the user;
power and control unit tethered to the earpiece for powering the video and audio circuitry and for controlling transmission of the video and audio signals from the earpiece; and
a receiver configured to receive the video and audio signals wirelessly from the power and control unit, and to further transmit the video and audio signals to a remote system via a network link.

11. The system of claim 10, wherein the receiver comprises a programmed computer local to the user.

12. The system of claim 10, wherein the receiver is configured to interface with the remote system to permit access to the remote system for transmission of the video and audio signals.

13. The system of claim 12, wherein access to the remote system is regulated based upon a subscription or a pay-per-use license arrangement.

14. A system for the capture and transmission of video and audio data comprising:
an earpiece configured to be worn by a user, the earpiece including video and audio circuitry for capturing video and audio signals corresponding to views seen by the user;
power and control circuitry for powering the video and audio circuitry and for controlling transmission of the video and audio signals from the earpiece;
a receiver configured to receive the video and audio signals wirelessly from the power and control circuitry; and
a remote system coupled to the receiver via a network link, the remote system receiving the video and audio signals from the receiver for playback.

15. The system of claim 14, wherein the remote system is configured to limit access by the receiver in accordance with a subscription or a pay-per-use license arrangement.

16. The system of claim 14, wherein the remote system is configured to further transmit the video and audio signals to a remote viewer coupled to the remote system via a further network link.

17. The system of claim 14, wherein the power and control circuitry is coupled to the earpiece via a tethered cable.

18. The system of claim 17, wherein the power and control circuitry is configured for wireless communication to the receiver.

19. The system of claim 14, wherein the power and control circuitry is integrated into the earpiece.

20. The system of claim 19, wherein the earpiece is configured for wireless communication to the receiver.

21. A method for the capture and transmission of video and audio data comprising:
capturing video and audio signals corresponding to views seen by a user via video and audio circuitry in an earpiece configured to be worn by a user;
providing power and control signals to the video and audio circuitry and for controlling transmission of the video and audio signals from the earpiece to a separate receiving device;
receiving the video and audio signals wirelessly from the power and control circuitry in a receiver; and
transmitting the video and audio signals from the receiver to a remote system coupled to the receiver via a network link.

22. The method of claim 21, comprising regulating access for transmission of the video and audio signals from the receiver to the remote system.

23. The method of claim 22, wherein access is regulated based upon a subscription or pay-per-use arrangement.

24. The method of claim 21, comprising providing the power and control signals to the video and audio circuitry by a tethered connection between the earpiece and a power and control unit.

25. The method of claim 21, comprising retransmitting the video and audio signals from the remote system to at least one viewer via a further network link.
